(19) United States
(12) Patent Application Publication
(10) Pub. No.: US 2013/0164403 A1
(43) Pub. Date: Jun. 27, 2013

(54) PATTY MAKING MACHINE

(71) Applicants: George Lambertus Josephus Maria Boogers, Uden (NL); Hendrikus Petrus Gerardus Van Gerwen, Someren (NL); Hendrik Jan Righolt, Oosterhour (NL)

(72) Inventors: George Lambertus Josephus Maria Boogers, Uden (NL); Hendrikus Petrus Gerardus Van Gerwen, Someren (NL); Hendrik Jan Righolt, Oosterhour (NL)

(73) Assignee: CFS BAKEL B.V, Bakel (NL)

(21) Appl. No.: 13/819,071

(22) PCT Filed: Aug. 17, 2011
(86) PCT No.: PCT/EP11/04133

§ 371 Date: Feb. 26, 2013

(30) Foreign Application Priority Data
Aug. 31, 2010 (EP) 10 009 039.8
Oct. 4, 2010 (EP) 10 013 264.6

(51) Int. Cl. A22C 7/00

(52) U.S. Cl. CPC A22C 7/0084
USPC 425/441; 426/513

(57) ABSTRACT

The present invention is related to a patty forming apparatus with a mould plate (17) that is reciprocable between two positions (3, 4) and that comprises cavities (5), which are filled in the filling station (6) with a patty material and which are emptied in the discharge station.

The present invention is related to a patty forming apparatus with a mould plate that is reciprocable between two positions and that comprises cavities, which are filled in the filling station with a patty material and which are emptied in the discharge station.

Such patty machines are known from the state in the art, for example EP 0 818 148. However, the patty machines according to the state of the art have the deficiency, that they have too much ware.

It was therefore the objective of the present invention to provide a patty machine that does not comprise the deficiencies according to the state of the art.

This problem is attained by a patty forming apparatus with a mould-plate that is reciprocable between two positions and that comprises cavities, which are filled in the filling station with a patty-material and which are emptied in the discharge station and which comprises a stationary plate, whereas it further comprises rolling elements located between the plate and the mould-plate.

The present invention relates to a patty forming apparatus. In the patty forming apparatus, a patty material for example any formable, eatable material such as dough, minced meat or the like, can be formed into a desired shape. This shape can be two dimensional, i. e. a disc or three dimensional, i. e. a ball. According to the present invention, the patty forming apparatus comprises a mould plate that reciprocates between two different positions; i. e. a filling and a discharge position. This mould plate comprises cavities, into which the patty material is filled, preferably pressed and thereby formed. The mould plate preferably comprises a multitude of cavities which are arranged in an array, i. e. which comprise a multitude of parallel rows, each row preferably comprising a multitude of cavities. The rows are preferably arranged perpendicular to the direction of motion of the mould plate. Preferably, the cavities in one row and/or one or more rows are filled simultaneously in the filling station. Preferably, the cavities in one row and/or one or more rows are then emptied simultaneously in the discharge station.

According to the present invention, the inventive patty forming apparatus comprises a plate, which is preferably part of the housing of the patty forming apparatus and thus stationary. Between this plate and at least one surface of the mould plate, rolling elements are arranged. These rolling elements reduce the friction of the mould plate during its motion between the two positions. Additionally the rolling elements provide a large contact area against which the mould plate can be pressed directly or indirectly. Due to the large contact area, no or only little pressure-peak occur and/or the mould plate does not bend.

Preferably, the rolling elements are provided in a cage, in order to prevent that the rolling elements touch each other and/or have always equal distance from each other

In a preferred embodiment of the present invention, the length of the rolling elements is essentially equivalent to the width of the mould plate, i.e. the horizontal extension of the plate perpendicular to its direction of motion. The rolling elements are preferably cylinders more preferably with a relatively small diameter, for example 10-30 mm, preferably 15-25 mm and even more preferably 19-21 mm. Preferably these cylinders are arranged side by side with a relatively small distance in between, i.e. only sufficient space that the cylinders do not touch each other. This preferred embodiment of the present invention assures, that there are no or little pressure peaks; i.e. that there is an equal pressure distribution along the mould plate, especially along the part of the mould plate where the mould cavities are located.

In another preferred embodiment of the present invention, the patty forming apparatus comprises a locking plate adjacent to the mould plate and fixed to the mould plate. Preferably the rolling elements are arranged between the stationary plate of the patty forming apparatus and the locking plate. The locking plate prevents that the material will be pressed out of the form plate and/or is utilized as a counter plate for the rollers to avoid indentations from the rollers into the form plate.

Preferably the patty forming apparatus comprises a bottom plate.

In another preferred embodiment of the present invention, the patty forming apparatus comprises a seal plate between the bottom plate and the mould plate. This seal plate seals especially the area around the inlet of the food forming material. Furthermore, the seal plate assures that the food forming material is only distributed in the cavity but not around the cavity. Material that stands out of the cavity is preferably cut off by the seal plate. Thus, in a preferred embodiment, the seal plate comprises cutting means to cut off food forming material that stands beyond the mould cavity.

Preferably, the seal plate is pressed against the mould plate with spring elements preferably adjustable spring elements. With the adjustment of the spring elements, the pressure between the seal plate and the bottom plate can be adjusted based on the food forming material. Furthermore, wear can be equalized.

Preferably, the mould plate comprises a porous mould region. In this porous mould region, the mould plate is made of a porous material, for example a sintered material. Through this porous material air can be ejected to remove the formed patties out of the cavities. Furthermore, the passages in the porous material can be utilized to vent the cavities.

Preferably, the porous mould region is an insert into a frame of the mould plate. Preferably, the insert comprises a multitude of cavities. The cavities are for example inserted into the porous mould region by metal cutting.

In another preferred embodiment, the mould region comprises one insert per cavity.

In a yet another preferred embodiment of the present invention, the patty forming apparatus comprises one or more means to divide the airflow between two or more cavities or rows of cavities. This embodiment of the present invention is especially advantageous to avoid air-shortcuts. Preferably this means is not only present in the gap between the air inlet and the mould- and/or the locking plate but extends also at least partially into the porous material. Additionally or alternatively, the means can be utilized to secure an insert in the plate and/or as a pressure member, to assure that the insert is tight relative to the form plate.

Another inventive or preferred embodiment of the present invention is a patty forming apparatus with a mould-plate that is reciprocable between two positions and that comprises cavities which are filled in the filling station with a patty-material and which are emptied in the removal station, whereas it comprises two discharge stations and one belt per removal station.

The present invention relates to a patty forming apparatus. In this patty forming apparatus, a patty material which is formable, for example a dough, minced meat or the like, can be formed into a desired shape. This shape can be two dimensional, i. e. a disc or three dimensional, i. e. a ball. According to the present invention, the patty forming apparatus comprises a mould plate that reciprocates between two different positions; i. e. a filling and a discharge position. This mould plate comprises cavities, into which the patty material is filled, preferably pressed and thereby formed. The mould plate preferably comprises a multitude of cavities which are arranged in an array, i. e. which comprise a multitude of parallel rows, each row preferably comprising a multitude of cavities. The rows are preferably arranged perpendicular to the direction of motion of the mould plate. Preferably, the cavities in one row and/or one or more rows are filled simultaneously in the filling station. Preferably, the cavities in one row and/or one or more rows are then emptied simultaneously in the discharge station.

According to the present invention, the inventive patty forming apparatus comprises two discharge stations, which are located to the left and the right of the filling station. The mold plate reciprocates between these two stations. In these discharge stations, the formed patties are removed from the cavity. According to the present invention, the inventive patty forming apparatus comprises an individual belt per removal station. Thus, the inventive apparatus can be operated with much more flexibility than the apparatus according to the state of the art. The two belts can be operated with the same or different speeds. The transportation direction of the two belts is preferably identical. Preferably, one belt is longer than the other and more preferably, the longer belt is operated at a higher speed than the shorter belt. Preferably, the belts are located at least partially at different heights. More preferably, at least one belt can comprise means to lower or lift it at least partially. In another preferred embodiment of the present invention at least one belt comprises different segments, which more preferably can be moved even more preferably rotated relative to each other.

Preferably, at least one belt comprises means to alter the height of the belt at least partially before and/or during the transportation of the patties. In a preferred embodiment, the belt is tilted and/or partial segments of a belt are lowered and lifted. This preferred embodiment of the present invention has the advantage that during the removal of the patties from the mold plate, the distance between the mold plate and the belt can be very small, so that deformation or destruction of the patties during their drop from the mould plate onto the belt can be avoided. During transportation along the belt however, the distance between the surface of the belt and the other parts of the inventive patty forming apparatus can be relatively large to avoid a collision between the formed patties on the belt and other parts of the inventive patty forming apparatus.

Preferably, the two belts are connected by a seesaw. One end of this seesaw can be brought into alignment with each of the belts. Thus, the patty load of the two belts can be combined on one belt, which is located downstream of the seesaw. The seesaw preferably also comprises a belt. This belt can be operated at different velocities than the velocities of the first and/or second belt of the patty forming apparatus in order to increase or decrease the distance between two patty rows. This holds also true for the transportation means downstream of the seesaw.

Preferably, at least one of the belts, the seesaw and/or the belt downstream are shiftable sidewardly, i.e. in a horizontal direction perpendicular to the direction of transportation. This preferred embodiment allows to stagger the patties on the belt.

According to a preferable or another inventive embodiment of the present invention, the mold plate is at least partially porous. Preferably, the cavities especially their bottom and their sidewall are made of a porous-, for example a sintered-material. This embodiment of the present invention has the advantage, that the patties can be ejected out of the plate for example with air. Additionally, the cavity can be vented via the porous material during filling of the cavities.

In another preferred or inventive embodiment of the present invention, the outlet of the filling station is below the mold plate. This embodiment of the present invention has the advantage, that the filling and the discharge of the mould-plate takes place on the same sides of the mold plate, so that there need not be any through-holes in the mold plate.

Preferably, the inventive patty forming apparatus comprises two outlet means, preferably two air outlet means to eject the patties out of the molds. This embodiment of the present invention has the advantage, that no pistons are needed to remove the patties from the mold plate.

According to another inventive or preferred embodiment of the present invention, the mold plate comprises a slot to accommodate a stick. The sticks are inserted into the patty and are utilized to hold the patty. The slot guides the stick during its insertion into the patty. The stick is preferably inserted into the patty by moving the mold plate relative to the stick and/or the stick relative to the mold plate. The slot has preferably a U-shaped, square or rectangular cross-section. Preferably, the slot is in connection with a cavity. This facilitates the insertion of the stick into the patty via the slot. Preferably, the slot extends from the cavity in the mold plate to the side-limit of the mold plate that is oriented perpendicular to the direction of motion.

Preferably, the mold plate comprises to rows of cavities, each row comprising at least one, preferably a multitude of cavities, whereas the cavity/cavities in one row are staggered to the cavity/cavities in the other row. This preferred embodiment of the present invention has the advantage that the patties can be placed on a belt in a staggered pattern without moving the belt sidewardly.

Another subject matter of the present invention is a process for the transportation of patties, whereas the patties are staggered. This embodiment of the present invention allows to increase the load on the belt per unit-length. Furthermore it has advantages regarding the subsequent processing and/or packaging of the patties.

Preferably, the patties comprise a stick, whereas the sticks point at least partially in different directions. Preferably, one stick points in the direction of motion of the transportation belt, while the next one points in the opposite direction.

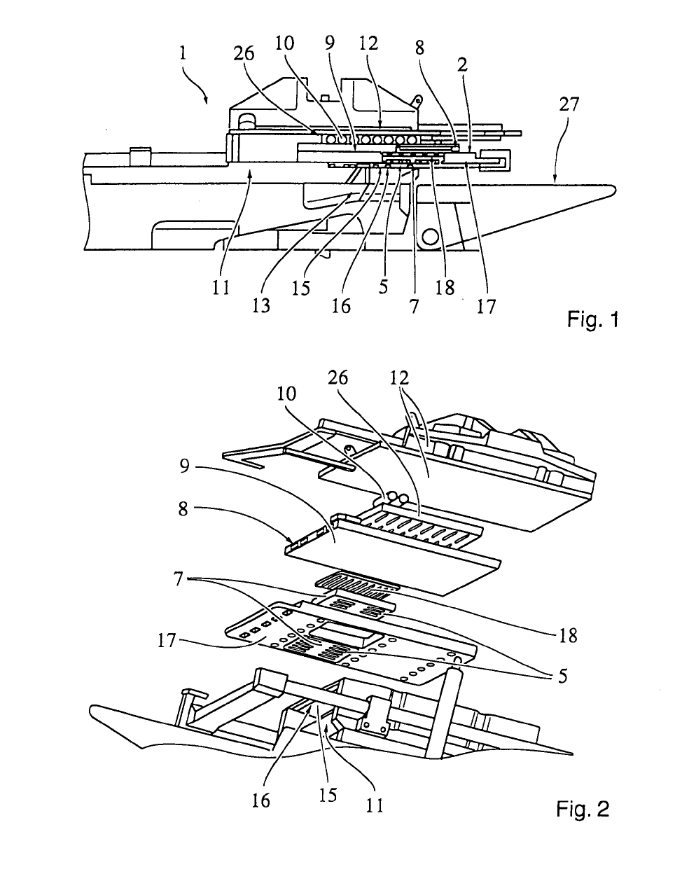

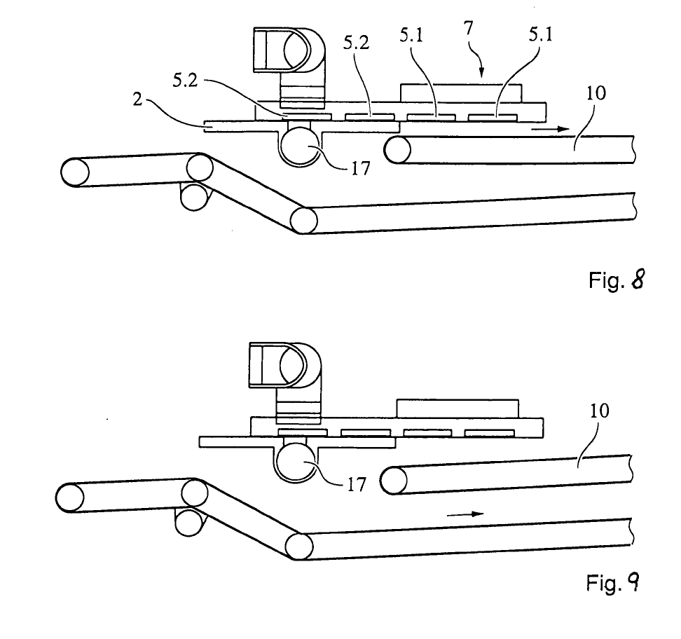

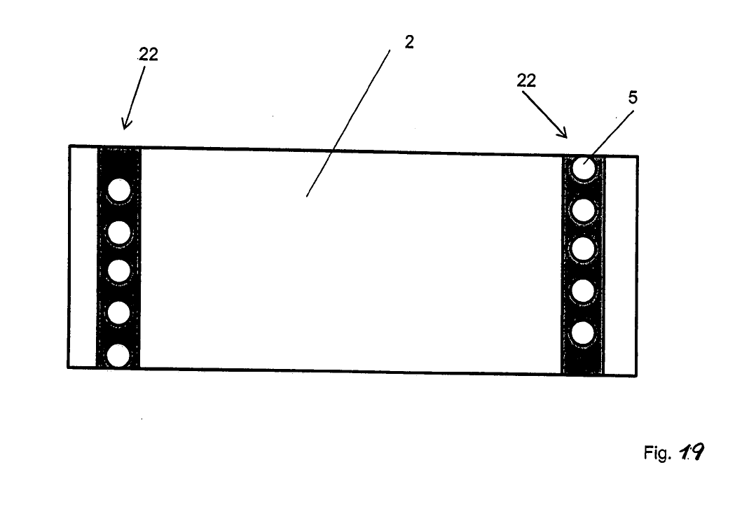

The inventions are now explained according to FIGS. 1-32. These explanations do not limit the scope of protection. The explanations apply to all inventive embodiments of the present invention likewise.

FIG. 1 shows a first embodiment of the patty forming apparatus.

FIG. 2 shows a second embodiment of the patty forming apparatus.

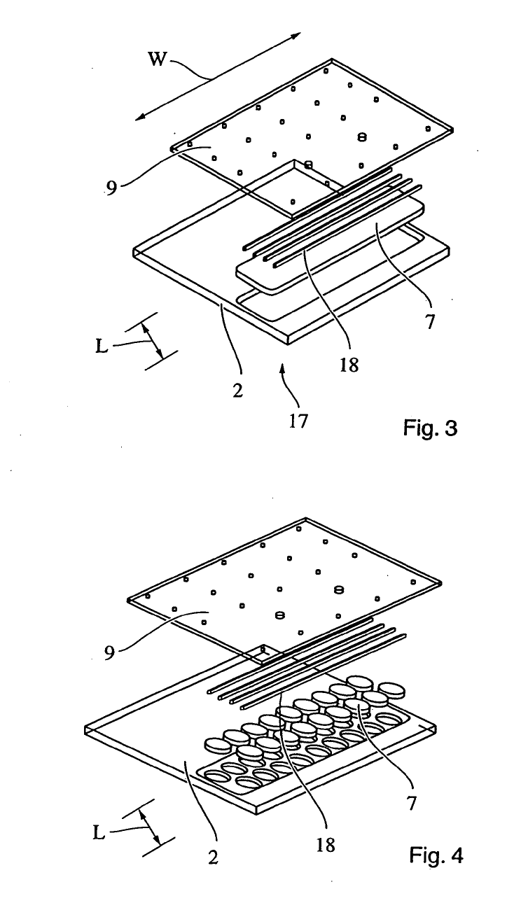

FIG. 3 shows a first embodiment of the mould plate.

FIG. 4 shows a second embodiment of the mould plate.

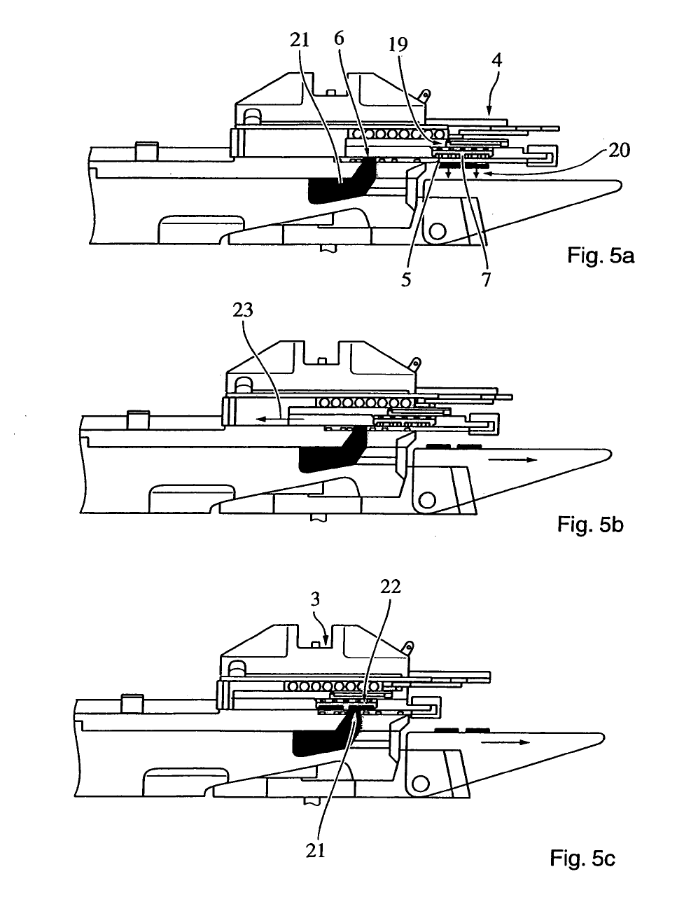

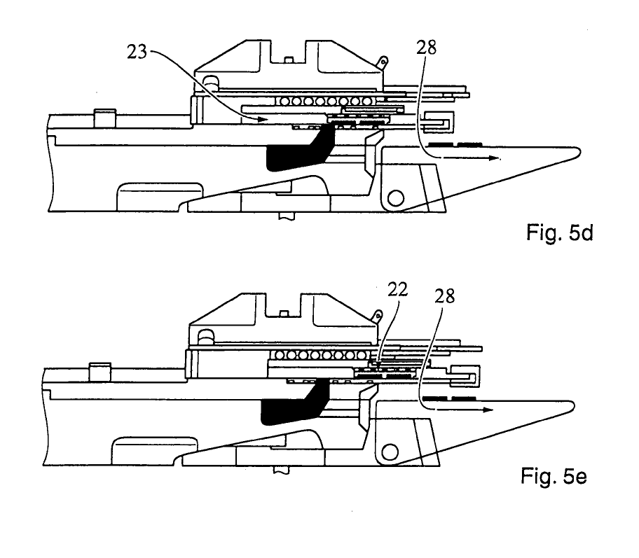

FIGS. 5a-5e show the operation of the inventive patty forming apparatus.

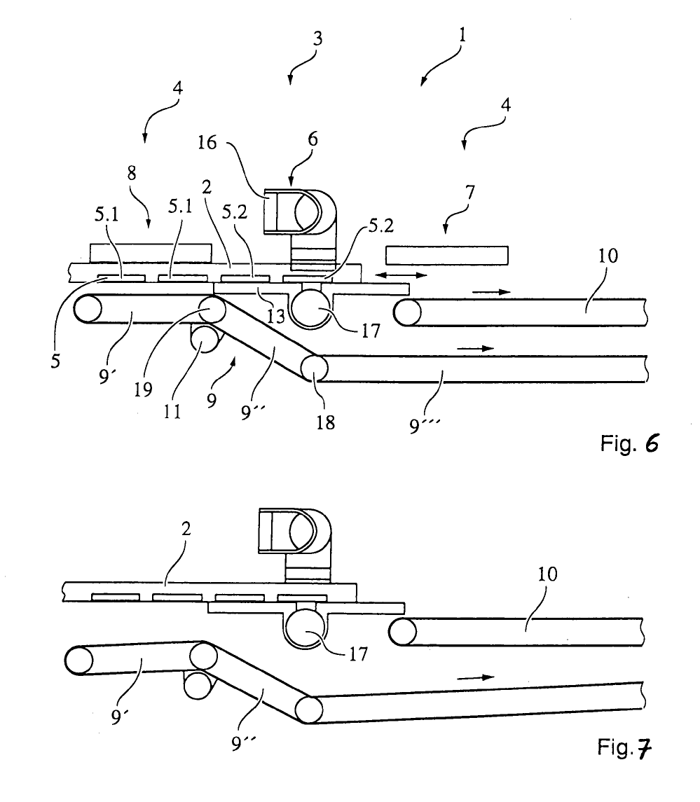

FIGS. 6-10 show the inventive patty forming apparatus and its operation.

FIGS. 11-16 show another embodiment of the inventive patty forming apparatus.

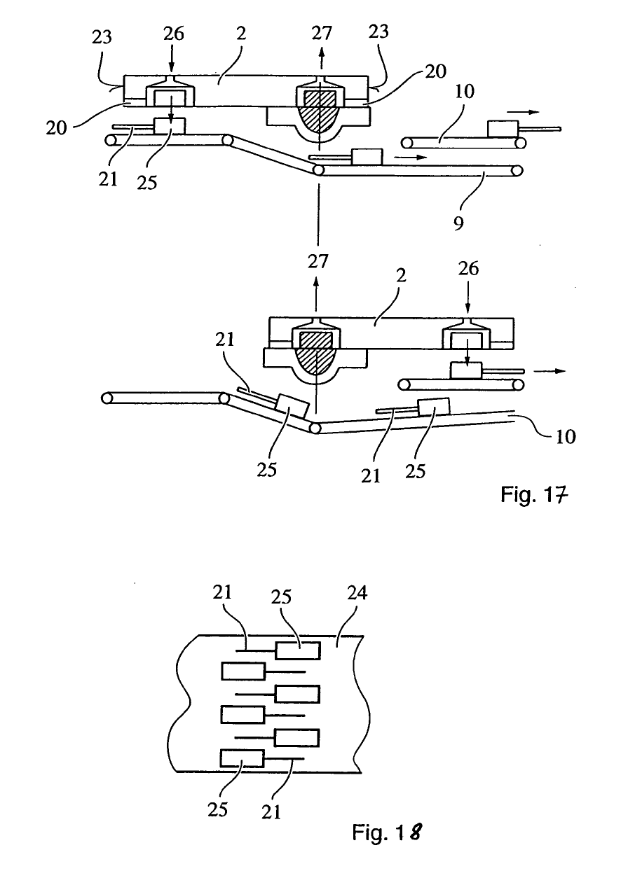

FIG. 17 shows the forming of patties with a stick.

FIG. 18 shows a belt loaded with staggered patties.

FIG. 19 shows a mold plate with staggered cavities.

FIG. 1 shows a first embodiment of an inventive patty forming apparatus. This patty forming apparatus comprises a top plate 12 and a bottom plate 11, which are stationary parts of the inventive apparatus, i.e. its frame. These plates 11, 12 confine a gap in which a mould plate 17 is located. The mould plate reciprocates between a filling position 3 and a discharge position 4. The mould plate 2 comprises a frame which is preferably made from a solid material. Furthermore, the mould plate comprises a porous mould region 7, which is made from a porous material for example from a sintered material. In this porous mould region 7, cavities 5 have been machine-cut. The porous mould region 7 preferably comprises an array of cavities 5, i. e. the cavities arranged in several rows whereas each row comprises a multitude of cavities. Each row extends preferably perpendicular to the direction of motion.

The cavities of the each rows are preferably emptied and filled simultaneously. The cavities of two or more rows can also be emptied and filled simultaneously. Adjacent to the top surface of a mould plate the inventive food forming machine comprises a locking plate 9. The locking plate protects the mould plate from above, for example against indentations from the rollers. Between the locking plate 9 and the top plate 12 a multitude of rolling elements 10 are arranged. These rolling elements extend preferably over the entire width W (please compare FIG. 16) of the mould plate 17. In the present case, the rolling elements 10 are cylinders with a small diameter, app. 20 mm. These cylinders are arranged side by side with a very small distance in between. In the present case, the pitch is 25 mm, so that the distance between the rollers is 5 mm. This preferred embodiment of the present invention assures an equal pressure distribution in the mould plate and no or little bending of the mould plate. The rolling elements 10 assure, that there is little friction between the mould plate and the frame of the patty forming apparatus, i. e. the stationary top plate 12 during its motion between the two positions. Furthermore, the inventive patty machine comprises an inlet, through which the patty material is inserted preferably pumped into the cavities 5. This inlet is located in a filling station 6 which itself is located in the filling position 3.

Furthermore, the inventive food forming machine comprises a discharge position 4, in which the formed patties are discharged from the mould plate for example onto a belt 27. In the present case pressurized air, which is forced through the porous material, is used to eject the formed patties. The patty forming apparatus therefore comprises in its discharge position 4 a discharge station, in the present case, means to force air through the porous region, especially through the cavities more specifically through the bottom and through the sidewalls of the cavity.

FIG. 2 shows a second embodiment of an inventive food forming machine. In comparison to the food forming machine according to FIG. 1, the present food forming machine additionally comprises a seal plate 15, which is located between the bottom plate 11 and the bottom surface of the mould plate 17. The seal plate 15 is pressed against the mould plate by spring elements 16, preferably adjustable spring elements 16. This pressure force also presses the mould plate against the locking plate 9 and the locking plate against the rolling elements 10. The seal plate seals the area around the inlet and assures that essentially all the food forming material is inserted into the cavities and not around the cavities. Furthermore, the seal plate cuts off material that stands beyond the cavities of the mould plate.

FIG. 3 shows a first embodiment of the mould plate 17. In the present case, the porous mould region is made from one piece, which is inserted for example pressed, screwed, welded, soldered or glued into the mould plate 2. The insert 7 comprises at its lower surface a multitude of cavities, arranged in an array of a multitude of rows, each row comprising a multitude of cavities 5. In order to assure, that there is no air-shortcut regarding the air which is pressed into the porous insert to eject the patties, the inventive food forming machine comprises diverters 18 (in the present case four diverters), which are located in the gap between the locking plate 9 and the mould plate 2 and which also extend into the surface of the porous-insert 7.

FIG. 4 shows another embodiment of the mould plate. In the present case, the porous elements are discrete elements, which are inserted into holes in the mould plate. One cavity comprises one individual porous element. Other than that, it is referred to the explanations according to FIG. 3.

FIG. 5 shows the operation of the inventive patty forming apparatus. In FIG. 5a, the cavities 5 are in the discharge position. In this discharge position 4, air is forced via an inlet into the cavities 5, especially into the porous mould region 7. The air flows through the porous mould region into the cavities and ejects the patties as depicted by arrow 20. The formed patties preferably fall on a belt and are transported their way. As soon as the patties have been discharged from the mould plate, the mould plate moves to the left as depicted by arrow 23 in FIGS. 5b. During the ingoing stroke and after the mould plate has reached its filling position 3 (FIG. 5c), food forming material is inserted into the cavities 5, preferably pressed into the cavities of the mould plate 17, which is depicted by arrow 21. The porous material can be used during this step to remove entrapped air from the cavities.

As depicted in FIG. 5d, the mould plate is moved back to its discharge position 4, as soon as the filling of the cavities is completed, and then again air is forced through ejection medium supply 8, to remove the formed patties out of the mould plate as can be seen in FIG. 5e.

FIG. 6 shows the inventive patty forming apparatus, which comprises a mold plate 2 with a multitude of cavities. In the present example, the mold plate comprises four rows of cavities, whereas each row comprises a multitude of cavities 5. The rows are oriented perpendicular to the motion of the mold plate 2. The motion of the mold plate is depicted by the double arrow. Furthermore, the inventive patty forming apparatus comprises one filling station 6 in which the patty material is pressed into one or more rows of cavities simultaneously. In the present example, two rows of cavities are filled simultaneously. Furthermore, the inventive patty forming apparatus comprises a first discharge station 7 and a second discharge station 8. In the embodiment according to FIG. 6 two rows of cavities 5.1 are presently emptied in the discharge station 8, while simultaneously two rows of cavities 5.2 are filled with the food forming material in the filling station 6. As can be seen from FIG. 6, each discharge station 7, 8 comprises its own belt 9, 10, whereas the first discharge station 8 is adjacent to belt 9 and the second discharge station 7 is adjacent to belt 10. In FIG. 6 the formed patties are presently loaded on belt 9 and transported in a direction depicted by the arrow. Belt 9 preferably comprises three segments 9′-9″″ whereas segments 9′ and 9″ are movable relative to segment 9′, preferably the belt comprises two axis 18, 19, whereas segment 9″ can turn around axis 18 relative to segment 9′″ and segment 9′ can turn relative to segment 9″ around axis 19. Furthermore, belt 9 comprises means 11, for example motor means, which can lower and lift belt 9 especially its segments 9′, 9″.

FIG. 7 shows the situation after the patties (not depicted) have been dropped on segment 9′ of belt 9. Afterwards, this belt is lowered to avoid a collision of the patties especially with the means of the filling station 6. The patties are transported from the left to the right as depicted by the arrow. Simultaneously or sequentially, mold plate 2 is moved into its second position (please compare FIG. 7) in which the cavities which have just been emptied are now filled with patty material in the filling station. The cavities which have been filled in the previous step have now been aligned with the second discharge station 7. In this discharge station air is ejected in order to eject the formed patties (not depicted) on belt 10. Subsequently, as can be seen in FIG. 22 belt 10 is tilted and thereby lowered in order to avoid a collision between the patties on the belt and the patty forming apparatus. Afterwards as can be seen from FIG. 10 the mold plate 9 is moved back into the position as already depicted in FIG. 6 and the process restarts.

As can be seen from FIGS. 6-10, the outlet 13 of the filling station, which is in the present case designed as a plate, has a width so that four rows of cavities can be filled simultaneously. Additionally, the outlet comprises a divider 17, for example a valve, that assures, that the patty material is only ejected through the segment of outlet plate 13 that is covered by the mold-plate.

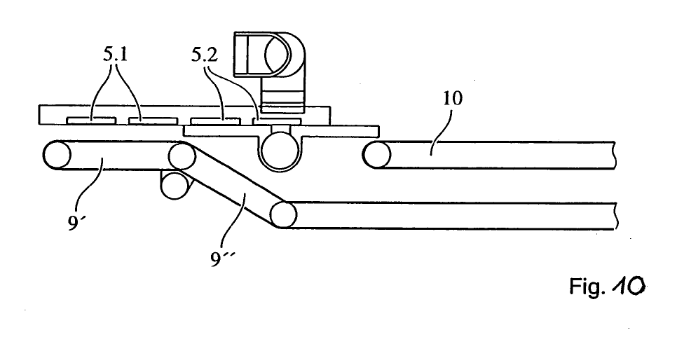

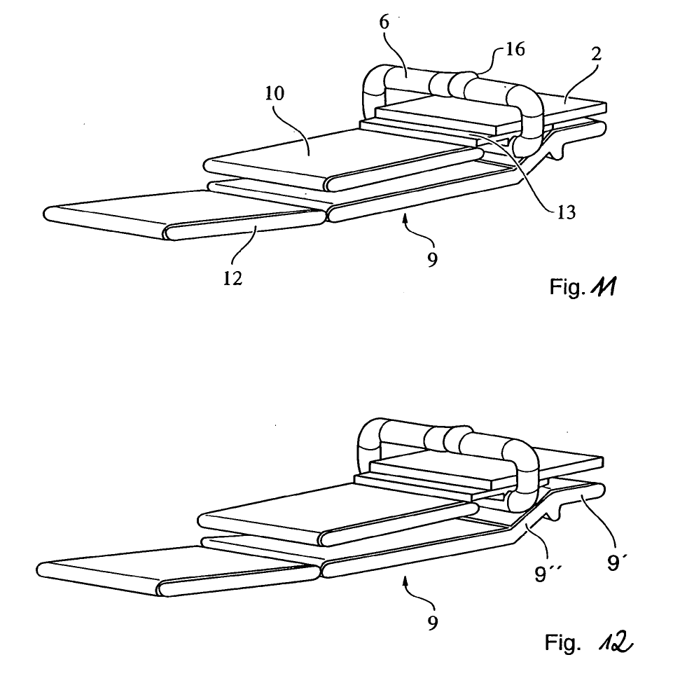

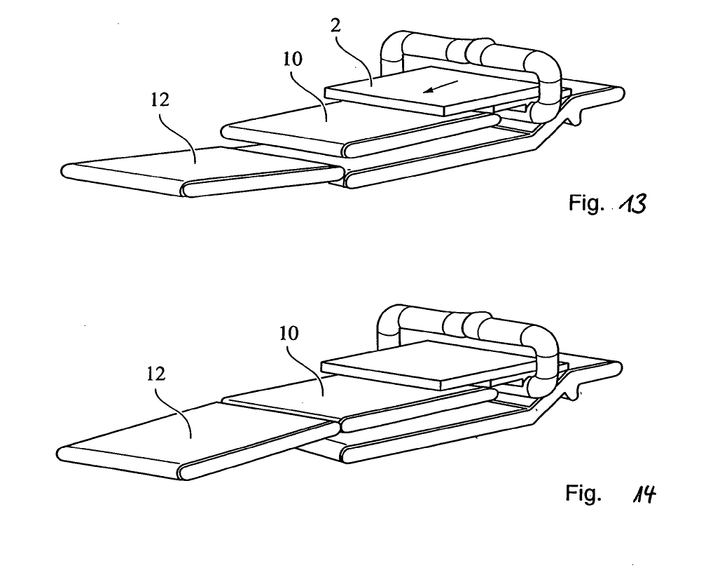

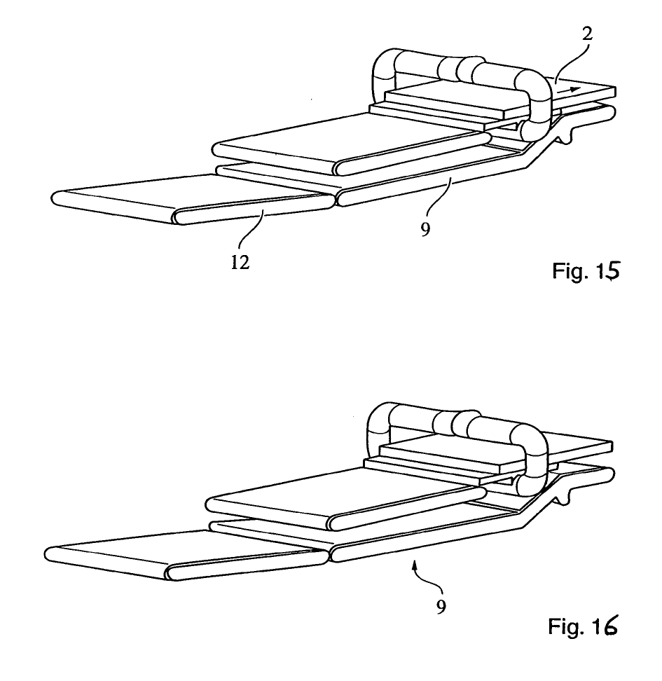

FIGS. 11-16 show a second embodiment of the present invention, which is essentially identical to the embodiment according to FIGS. 6-10 so that the disclosure regarding FIGS. 6-10 also applies to this embodiment. In this embodiment, the first belt 9 is made from one segment and is tilted in order to increase the space between the belt 9 and the filling station especially the distance between segment 9′ and filling the filling station. Additionally, this embodiment of the present invention comprises a seesaw 12, which can be aligned either with belt 9 or with belt 10. In FIG. 11 the patties are loaded on belt 9. Thus, the seesaw 12 is aligned with this belt 9. Then, as can be seen in FIG. 13, the mold plate 2 is moved into its second position in which the mold cavities are emptied on belt 10. During this movement or afterwards, the seesaw 12 is tilted so that it is aligned with belt 10, as can be seen in FIG. 14. Then, as depicted in FIGS. 15 and 16, the mold plate 2 is moved back into its initial position (please compare FIG. 11) and the seesaw is again aligned with belt 10. Due to the seesaw, the loads of the belts 9 and 10 can be combined on one belt. The seesaw 12 or a belt that is downstream of the seesaw can be operated at a different speed than the seesaw itself or belts 9 and 10 in order to increase or decrease the distance between two rows.

FIG. 17 shows yet another embodiment of the present invention. In the present case, sticks 21 are inserted into the patties after and/or while the patties are formed. The mold plates therefore comprise one slot 20 per cavity, which guides the stick during its insertion into the patty. The stick can be inserted into the patty by moving the stick and/or by moving the mold plate. The slots 20 are open towards the bottom and extend from the cavity towards the side limit 23 of the mold plate 2 that is perpendicular to the motion of the mold plate which is depicted by the double arrow. Due to the opening of the slot 20 towards the bottom, the patty plus the stick can be easily deformed from the cavity of the mold plate. Due to the direction of the slot in the plate, patties are formed whose stick points in the direction of the motion of the belt (patties on belt 10) and whose stick is directed opposite of the motion of the belt (patties on transportation belt 9).

By means of for example a seesaw 12 as depicted in FIGS. 11-16, a pattern as depicted in FIG. 18 can be created. The person skilled in the art understands that this pattern also requires that belt 9, belt 10, the sea saw and/or belt 24 downstream of belt 9 and 10 and/or the seesaw have to be movable sideward, i.e. horizontally and perpendicularly to the direction of motion of the belt and/or a motion with such a component. The pattern according to FIG. 31 has the advantage, that the patty load per unit area of a belt can be increased which is advantageous for further processing of the patties and/or the packaging of the patties because a relatively smaller package is needed. The person skilled in the art understands that this is also true for patties without a stick.

Staggered patties as depicted in FIG. 18 can also be achieved by arranging the cavities in the mold plate 2 in a staggered mode, as depicted in FIG. 19. With such a mold plate, the sideward motion of one of the belts and/or the seesaw is not needed.

### LIST OF REFERENCE SIGNS

1 patty forming apparatus
2 mould plate
3 filling position
4 discharge position
5 base member, cavities
5.1 cavities being emptied
5.2 cavities being filled
6 filling station
7 porous mould region, second discharge station
8 ejection medium supply, first discharge station
9 locking plate, first belt
9′-9′″ segments of the first belt
10 cylinder, second belt, rolling element
11 plate, bottom plate, means
12 plate, top plate, seesaw
13 inlet, outlet of the filling station
14 outlet, first outlet means
15 seal plate, second outlet means
16 spring element, inlet of the filling station
17 mould plate, divider
18 spring element, divider, axis
19 ejection medium, air, axis
20 arrow, dropping patty, slot
21 patty-material supply, stick
22 product in the cavity, row of cavities
23 movement of the plate, side limit
24 belt
25 patty
26 roller cage, gas, air
27 belt, vent
28 patty transport
W width of the mould plate
L region, in which the cavities are arranged, porous mould region

1. A patty forming apparatus comprising:
a mould-plate that is reciprocable between two positions and that comprises cavities, which are filled in a filling station with a patty-material and which are emptied in a discharge station and which comprise a stationary plate; and
wherein the patty forming apparatus comprises rolling elements located between a plate and the mould-plate, the rollers being provided in a cage.

2. The patty forming apparatus according to claim 1, wherein a length of the rolling elements is essentially equal to a width of the mould plate.

3. The patty forming apparatus according to claim 1, wherein the patty forming apparatus comprises a bottom plate and the rolling elements are arranged at least over a length of a region, in which the cavities are arranged.

4. The patty forming apparatus according to claim 1, wherein the patty forming apparatus comprises a locking plate adjacent to the mould-plate, and
wherein the rolling elements are arranged between the plate and the locking plate.

5. The patty forming apparatus according to claim 1, wherein the patty forming apparatus comprises a bottom plate.

6. The patty forming apparatus according to claim 5, wherein the patty forming apparatus comprises a seal plate between the bottom plate and the mould-plate.

7. The patty forming apparatus according to claim 6, wherein the seal plate is pressed against the mould-plate with adjustable spring elements.

8. The patty forming apparatus according to claim 1, wherein the mould plate comprises a porous mould region, and
wherein the porous mould region comprises one insert per cavity.

9. The patty forming apparatus according to claim 8, wherein the porous mould region is an insert that comprises a multitude of cavities, and
wherein the patty forming apparatus comprises a divider to divide air flow between two or more cavities.

10. (canceled)

11. (canceled)

12. A patty forming apparatus comprising:
a mould-plate that is reciprocable between two positions and that comprises cavities which are filled in a filling station with a patty-material and which are emptied in a removal station,
wherein the patty forming apparatus comprises two discharge stations, wherein the patty forming apparatus comprises at least one belt per removal station.

13. The patty forming apparatus according to claim 12, wherein the at least one belt comprises means to at least partially lift and lower.

14. The patty forming apparatus according to claim 12, wherein the at least one belt comprises means to at least partially alter a height of the belt during transportation of patties.

15. The patty forming apparatus according to claim 12, wherein the wherein the at least one belt is connected to a seesaw.

16. The patty forming apparatus according to claim 12, wherein the at least one belt is shiftable sideward.

17. The patty forming apparatus according to claim 12, wherein the mould plate is at least partially porous, and
wherein the patty forming apparatus comprises outlet means to eject patties out of the mould plate

18. The patty forming apparatus according to one claim 12, wherein an outlet of the filling-station is below the mold plate, and
wherein the mold plate comprises a slot to accommodate a stick, and the slot is connected with a cavity.

19. (canceled)

20. (canceled)

21. (canceled)

22. A patty forming apparatus according to claim 18, wherein the slot extends from the cavity to a side-limit of the mold plate.

23. A patty forming apparatus according to claim 12, wherein the mold plate comprises two rows of cavities, each row comprising at least oen cavity, wherein the cavity in one row is staggered to the cavity in the other row.

24. A process for transporting patties, wherein the patties are staggered.

25. The process according to claim 24, wherein the patties comprise a stick, and
wherein the sticks point at least partially in different directions.
